(19) United States
(12) Patent Application Publication
(10) Pub. No.: US 2012/0301749 A1
(43) Pub. Date: Nov. 29, 2012

(54) CELL ASSEMBLY AND BATTERY SYSTEM

(76) Inventors: Satoshi OKANO, Osaka (JP); Yoshihiro Tsukuda, Osaka (JP)

(21) Appl. No.: 13/479,617

(22) Filed: May 24, 2012

(30) Foreign Application Priority Data
May 27, 2011 (JP) 2011-119394

(51) Int. Cl. H01M 2/22; H01M 2/00

(52) U.S. Cl. 429/7; 429/158

(57) ABSTRACT

The purpose of the present invention is to provide a cell assembly in which single cells composed of secondary cells can be compactly linked, the single cells can be securely fixed in place so as not to become misaligned with each other; and to obtain a battery system in which cell assembly modules using the cell assembly can be compactly assembled. Cell assemblies (M1 through M4) are created in which a joint (21) between a cover member (12) and an exterior case (11) protrudes outward from the external peripheral edge of an exterior case, and linking members (7) are interposed for linking the plurality of secondary cells together into a single unit; and a battery system (BS) is created by vertically connecting a plurality of modularized cell assembly modules MJ in which a circuit unit (80) is combined into a single unit on one side of each cell assembly.

This application is based upon and claims the benefit of priority from the corresponding Japanese Patent Application No. 2011-119394 filed May 27, 2011, the entire contents of which are incorporated herein by reference.

### BACKGROUND OF THE INVENTION

1. Field of the Invention

The present invention relates to a cell assembly in which a plurality of secondary cells is connected, and to a battery system which uses the cell assembly.

2. Description of Related Art

Lithium secondary cells have high energy density and can be used in applications having small size and weight, and are therefore used as power supply cells for mobile telephones, notebook-type personal computers, and other portable electronic devices. Lithium secondary cells can also be endowed with high capacity, and have therefore come to be used also as motor drive power supplies for electric automobiles (EV), hybrid electric automobiles (HEV), and the like, and as storage cells for power storage.

In the lithium secondary cell described above, an electrode group in which positive electrode plates and negative electrode plates are arranged facing each other with separators therebetween are housed inside an exterior case which constitutes a cell canister, and an electrolyte solution is filled into the cell canister, and the lithium secondary cell is provided with a positive-electrode collector terminal linked to positive-electrode collector tabs of the plurality of positive electrode plates, a positive-electrode external terminal electrically connected to the positive-electrode collector terminal, a negative-electrode collector terminal linked to negative-electrode collector tabs of the plurality of negative electrode plates, and a negative-electrode external terminal electrically connected to the negative-electrode collector terminal

The use of a plurality of interconnected lithium secondary cells such as the one described above as a large-scale power supply is being investigated, and a cell assembly has been proposed in which single cells composed of a secondary cell provided with a stacked-type electrode group are stacked vertically, for example (see Patent Citation 1: Japanese Laid-open Patent Publication No. 2003-288883, for example).

In a lithium secondary cell provided with a stacked-type electrode group, a configuration is adopted in which an electrode group in which a plurality of positive electrode plates and negative electrode plates is stacked with separators therebetween is housed in an exterior case, and a non-aqueous electrolyte solution is filled into the exterior case. Also provided are a positive-electrode collector terminal linked to positive-electrode collector tabs of the respective positive electrode plates, an external terminal electrically connected to the positive-electrode collector terminal, a negative-electrode collector terminal linked to negative-electrode collector tabs of the respective negative electrode plates, and an external terminal electrically connected to the negative-electrode collector terminal

In order to increase the capacity of a lithium secondary cell thus configured, the surface area of the positive electrode plates and negative electrode plates, the number of layers, and the amount of included electrolyte solution must be increased. The single cell provided with a stacked-type electrode group is therefore manufactured so as to have a large surface area and thickness.

In a stacked-type lithium secondary cell, gas generated inside the cell canister causes the cell canister to expand, and when gaps widen between the stacked positive electrode plates and negative electrode plates, internal resistance increases, and can reduce the capacity of the cell. In addition to deformation of the respective cell canisters of the secondary cells (single cells), when the structure of the stacked cell assembly changes shape, the connecting terminals at which the cell canisters are connected to each other also deform and are damaged, and the desired cell capacity may become impossible to obtain.

Specifically, in a case in which a cell assembly is constructed by stacking a plurality of single cells each provided with a stacked-type electrode group, it is important to suppress expansion of the single cells and to secure the assembly so that the plurality of single cells does not become misaligned or deformed. A battery system has therefore been proposed in which a cell block securely fixed using a fixing member is used when a plurality of square cells is stacked (see Patent Citation 2: Japanese Laid-open Patent Publication No. 2010-157450, for example).

A plurality of secondary cells can be electrically connected to create a cell assembly having a large cell capacity, and a large-capacity battery system can be constructed by combining a plurality of cell assemblies. However, such a battery system formed by battery assemblies preferably has a compact configuration when used in a home or vehicle. Even when the battery system is compact, there may be a need for the battery system to have a small height, a small transverse width, or a small depth according to the installation site or environment.

In the case of a battery system for home use, for example, since the battery system may be installed outdoors, such as under eaves, under a window, or elsewhere, it is preferred that the battery system be configurable so as to have a small height and depth in order to be adaptable to installation in a narrow space between houses.

It is also preferred that expansion be suppressed in the housed plurality of single cells, that the single cells each be securely fixed in place so as not to become misaligned, and that the work of installation or wiring connection during installation be facilitated.

A cell assembly is therefore preferably configured so that wiring connection is facilitated and the plurality of single cells can be compactly linked when the cell assembly is constructed using single cells composed of stacked-type secondary cells. When a battery system is constructed using this cell assembly, the battery system is preferably configured so that a plurality of cell assemblies can be compactly assembled, space for connecting the terminals of the cell assemblies can be conserved so that less space is used, and wiring connection is facilitated.

### SUMMARY OF THE INVENTION

In view of the problems described above, an object of the present invention is to provide a cell assembly in which single cells can be compactly linked, the single cells can be securely fixed in place so as not to become misaligned with each other, and wiring connection is facilitated, and to provide a battery system in which cell assembly modules using the cell assembly can be compactly assembled, and wiring connection and other operations can be facilitated.

The present invention for achieving the abovementioned objects is a cell assembly comprising a plurality of linked stacked-type secondary cells each provided with an electrode group in which a plurality of positive electrode plates and negative electrode plates is stacked interposed by a separator; wherein the secondary cells are each provided with an exterior case for housing the electrode group, external terminals provided to opposing surfaces on both sides of the exterior case, and a cover member for sealing an open part of the exterior case, an electrolyte solution is injected into a cell canister formed by the exterior case and the cover member, and a joint between the exterior case and the cover member is provided so as to protrude outward from an external peripheral edge of the exterior case; and a linking member for linking together into a single unit the plurality of secondary cells is interposed so as to hold the joint on a top level and the joint on a bottom level therebetween, the joints being stacked vertically in the stacking direction of the plurality of secondary cells.

Through this configuration, since the plurality of vertically stacked secondary cells is linked together via the joints protruding on the sides of the cell canisters, a linked configuration is obtained whereby the height thereof in the stacking direction can be minimized. Since the external terminals are also provided on the sides of the cell canisters, electrical connections can also be made on the sides of the cell canisters, and the stack can be formed compactly in the height direction. A cell assembly can therefore be obtained in which wiring connection is facilitated and the plurality of secondary cells (single cells) can be compactly linked and securely fixed in place so that single cells do not become misaligned with each other.

In the cell assembly of the present invention configured as described above, the linking member comprises fastening means for holding the bottom-level joint and top-level joint of the plurality of stacked secondary cells therebetween and fixing together into a single unit the plurality of secondary cells, and the linking member links together into a single unit the plurality of secondary cells via the joints on the sides on which the external terminals are provided, while staying clear of the external terminals and of a terminal connecting member for connecting upper and lower external terminals to each other. Through this configuration, since both side parts of the plurality of stacked secondary cells are sandwiched in the vertical direction and fixed together in place into a single unit, expansion of the plurality of stacked secondary cells can be effectively suppressed, and the secondary cells can each be securely fixed in place so as not to become misaligned. Since the linkage also stays clear of the external terminals and of the terminal connecting member on the sides, a compact width can be achieved.

In the cell assembly of the present invention configured as described above, the linking member is provided with a circuit unit for protecting the plurality of secondary cells. Through this configuration, since the circuit unit is provided on a side of the cell canisters, the height in the stacking direction can be minimized. Electrical connection between the stacked and linked secondary cells can also be performed at the side of the cell canisters, and wiring can be facilitated even when a unit chassis having a restricted height is used.

In the cell assembly of the present invention configured as described above, the linking member has a retention function of holding the plurality of stacked secondary cells therebetween, an electrical function of placing the circuit unit in a position away from the cell canisters, and a protective function of containing and protecting the external terminals, the terminal connecting member for connecting upper and lower external terminals to each other, and other components. Through this configuration, the use of such a linking member in the cell assembly enables compact assembly, maintains electrical safety, and facilitates wiring connection in the cell assembly.

In the cell assembly of the present invention configured as described above, the fastening means comprises first engaging plates for engaging with the top-level joint, second engaging plates for engaging with the bottom-level joint, and fastening bolts for tightening the first engaging plates and the second engaging plates. Through this configuration, since the plurality of stacked secondary cells is attached and fixed in place in the vertical direction via the fastening bolts, expansion of the plurality of linked secondary cells is suppressed, and the secondary cells can each be securely fixed in place so as not to become misaligned.

In the cell assembly of the present invention configured as described above, the linking member is provided with a main body shorter in length than the height of the plurality of stacked secondary cells, and the main body is provided with a first gap part for preventing interference with the joints of the plurality of stacked secondary cells, a second gap part for preventing interference with the external terminals and the terminal connecting member, and bolt installation holes for installing the fastening bolts on both left and right sides of the second gap part; the fastening bolts are installed in the bolt installation holes on the left and right sides, the first engaging plates are installed on the fastening bolts and engaged with the top-level joint, the second engaging plates are installed on the fastening bolts and engaged with the bottom-level joint, the fastening bolts are rotated and attached, and the plurality of stacked secondary cells is held together as a single unit and fastened. Through this configuration, since a linking member is used in which the main body thereof is shorter in length than the height of the plurality of stacked secondary cells, the height of the cell assembly can be kept to a minimum. Since a linking member is used that has gap parts for preventing interference with the external terminals or the joints on the sides of the plurality of stacked secondary cells, a compact configuration can be obtained in which there is no significant protrusion in the lateral direction. Since the plurality of stacked secondary cells is attached and fixed in place in the vertical direction by rotating the fastening bolts, the operations of linking and fastening the plurality of secondary cells can easily be performed.

In the cell assembly of the present invention configured as described above, the linking member is formed of a resin having insulating properties. Through this configuration, no leakage of electricity occurs through the linking member when a plurality of secondary cells is linked via the linking member, and a predetermined cell capability can be normally demonstrated.

In the cell assembly of the present invention configured as described above, the vertically stacked cell canisters are insulated from each other. Through this configuration, even when secondary cells are composed of cell canisters having inadequate insulation, by insulating the cell canisters from each other (e.g., by stacking the cell canisters with insulating sheets therebetween), upper and lower cell canisters are reliably insulated from each other, short-circuiting of stacked cell canisters with each other is reliably prevented, and a predetermined cell capability is normally demonstrated.

In the cell assembly of the present invention configured as described above, external terminals protruding on the sides of the plurality of stacked secondary cells have alternatingly opposite polarities, and upper and lower external terminals are sequentially connected in series. Through this configuration, by connecting the external terminals protruding at the sides of each cell canister so as to alternate in the vertical direction, a plurality of secondary cells can be connected in series, and linked wiring connection aimed at increasing the capacity can be easily performed.

The present invention is also a battery system comprising a plurality of connected cell assembly modules in which a circuit unit including a protective circuit and a wiring part is combined into a single unit and modularized with one side part of the cell assembly described above; wherein a unit chassis is provided with a plurality of levels of shelves in which a plurality of the cell assembly module is individually housed, and a power distribution part is provided on a side of the unit chassis on which the circuit unit is provided.

Through this configuration, since each of the cell assembly modules is configured so that the height thereof is minimized, a unit chassis having a low height can be used even in a configuration in which a plurality of cell assembly modules is installed in stacked fashion. Since the battery system is constructed such that the plurality of cell assembly modules is stacked in the height direction and a power distribution part is provided on one side thereof, wiring connection and other operations can be performed from the one side on which the power distribution part is provided. A battery system can therefore be obtained in which the cell assembly modules can be compactly assembled, and wiring connection and other work can easily be performed.

In the battery system of the present invention configured as described above, when the cell assembly modules are connected to each other, the external terminals protruding on the side on which the circuit unit is provided are connected to each other via connecting terminals, and connected bottom-side external terminals and top-side external terminals have mutually different polarities. Through this configuration, when a plurality of cell assembly modules is installed, external terminals on the same side of upper and lower cell assembly modules can be connected to each other in series, and wiring connection is therefore facilitated. Since upper and lower cell external terminals are directly connected to each other using the connecting terminals, there is no need to devise extra wiring routes, and the gaps between upper and lower cell assembly modules can be minimized.

In the battery system of the present invention configured as described above, the shelves are provided with an open space for allowing the connecting terminals to be installed in a substantially straight line. Through this configuration, the external terminals on the same side of upper and lower cell assembly modules can be directly linked to each other using a connecting terminal Connection is therefore facilitated, and the gaps between upper and lower cell assembly modules can be minimized

In the battery system of the present invention configured as described above, the unit chassis has a raised floor part of a predetermined height disposed on a pedestal, the raised floor part being disposed between the pedestal and the shelves, and the shelves and the power distribution part are provided on top of the raised floor part. Through this configuration, since the raised floor part of a predetermined height is present on the pedestal, water does not penetrate into a cell assembly module or the power distribution part and cause short-circuiting or other malfunctions even when rain or other precipitation falls and water accumulates on the periphery thereof The raised floor part also acts as an air passage for allowing the flow of cooling air, and enables an efficiently operable battery system to be obtained.

### BRIEF DESCRIPTION OF THE DRAWINGS

FIG. 1 is a rough sectional view showing an embodiment of the cell assembly according to the present invention;

FIG. 2 is a rough plan view of FIG. 1;

FIG. 3 is a rough sectional view showing a second embodiment of the cell assembly;

FIG. 4A is a perspective view showing the relevant parts of the connecting member;

FIG. 4B is an enlarged view showing the relevant parts of the fastening means;

FIG. 5 is a rough sectional view showing a third embodiment of the cell assembly;

FIG. 6 is a rough sectional view showing a fourth embodiment of the cell assembly;

FIG. 7 is an exploded perspective view showing the secondary cell;

FIG. 8 is an exploded perspective view showing the electrode group provided to the secondary cell;

FIG. 9 is a perspective view showing the finished secondary cell;

FIG. 10 is a rough sectional view showing the electrode group;

FIG. 11 is a rough front view showing the overall configuration of the battery system according to the present invention;

FIG. 12 is a side view of FIG. 11; and

FIG. 13 is a rough view showing the overall configuration of the conventional battery system.

### DETAILED DESCRIPTION OF PREFERRED EMBODIMENTS

Embodiments of the present invention will be described hereinafter with reference to the accompanying drawings. The same reference numerals are used to refer to members that are the same in each drawing, and detailed descriptions thereof will not be repeated.

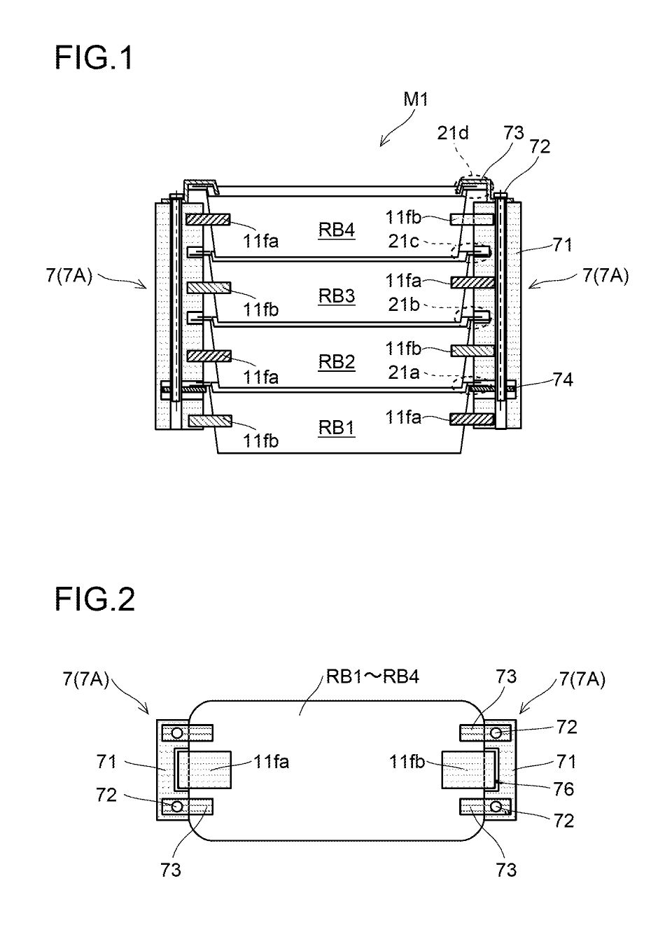

The cell assembly M1 according to the present embodiment will be described using FIGS. 1 and 2. FIG. 1 is a rough sectional view showing the overall configuration of the cell assembly M1 according to a first embodiment, and FIG. 2 is a rough plan view of the same. The cell assembly M1 is configured such that a large cell capacity is obtained by connecting a plurality of single cells composed of stacked-type secondary cells, and the cell assembly M1 is formed by stacking and linking together into a single unit a plurality of single cells, e.g., four single cells RB1, RB2, RB3, RB4, as shown in FIG. 1.

Linking members 7 (7A) for linking and fixing the plurality of stacked single cells in place are interposed on both sides on which external terminals 11f (11fa, 11fb) are arranged.

As described hereinafter, each of the single cells RB1, RB2, RB3, RB4 is provided with an electrode group, an exterior case for housing the electrode group, and a cover member for sealing an open part of the exterior case. The exterior case and the cover member are joined and sealed by a joint 21 (21a through 21d) to form a cell canister. The joint 21 is provided so as to protrude outward from an external peripheral edge of the exterior case, and the linking members 7 (7A) link the plurality of stacked single cells (secondary cells) while staying clear of the external terminals and of a terminal connecting member for connecting upper and lower external terminals to each other.

Since the single cells are linked via the joints 21 protruding at the sides of each cell canister, the linking members 7 (7A) for fixing the plurality of single cells (secondary cells) in place can be smaller in the direction in which the cells are stacked, and the size of the cell assembly M1 can be minimized.

The linking members 7 (7A) hold the bottom-level joint 21a and top-level joint 21d of the plurality of stacked secondary cells (single cells RB1, RB2, RB3, RB4) therebetween, and are each provided with a fastening means for fixing together into a single unit the plurality of secondary cells, and link the plurality of secondary cells while staying clear of the external terminals and of a terminal connecting member for connecting upper and lower external terminals to each other. Through this configuration, since both side parts of the plurality of stacked secondary cells are sandwiched in the vertical direction and fixed together in place into a single unit, expansion of the plurality of stacked secondary cells can be effectively suppressed, and the secondary cells can each be securely fixed in place so as not to become misaligned. Since the linkage also stays clear of the external terminals and of the terminal connecting member on the sides, a compact width can be achieved.

Upper and lower external terminals 11f (11fa, 11fb) protruding on the sides of the plurality of stacked single cells (secondary cells) have opposite polarities, and upper and lower external terminals (e.g., external terminals 11fa and 11fb) are preferably sequentially connected in series. Through this configuration, by connecting the external terminals 11fa, 11fb protruding at the sides of each cell canister so as to directly alternate in the vertical direction, a plurality of secondary cells can be connected in series, and wiring connection aimed at increasing the capacity can be easily performed in less space.

Specifically, the single cells RB1, RB2, RB3, RB4 are stacked in this order, as shown in the drawings. This stacking is performed so that the external terminals 11f provided so as to protrude from the side surfaces of the exterior cases have opposite polarities alternating in the vertical direction. For example, the single cells are stacked so that the negative external terminal 11fb of the single cell RB2 is placed above the positive external terminal 11fa of the single cell RB1. Through this configuration, the positive external terminals 11fa stacked on one side on the outside of the cell canisters and the negative external terminals 11fb stacked on the other side are directly connected, and upper and lower single cells can be electrically connected to each other in series.

As shown in the plan view of FIG. 2, each linking member 7 (7A) is a block, bracket-shaped in cross-section, having a gap part (second gap part 76 described hereinafter) communicated in the vertical direction so as to stay clear of the external terminals and of a terminal connecting member (not shown) for connecting upper and lower external terminals to each other. Engaging plates are installed above and below on both the left and right sides of the second gap part 76, and the plurality of stacked single cells RB1, RB2, RB3, RB4 above and below can be fixed together in place into a single unit by tightening the engaging plates above and below via fastening bolts 72.

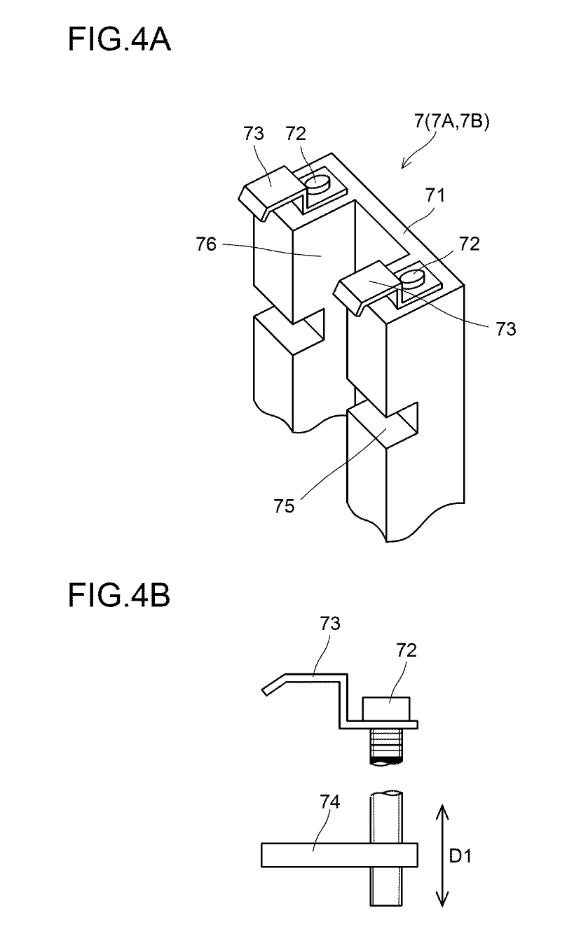

For example, a pair of engaging plates may be installed above and below and provided with engaging tabs for engaging on both the left and right sides of the second gap part 76, and the upper and lower engaging plates may be tightened via the fastening bolts 72. As shown in the drawing, engaging plates may be installed on both the left and right sides of the second gap part 76 and each tightened via a fastening bolt 72. A specific example of the configuration of the linking members 7 will next be described using FIGS. 4A and 4B.

The linking member 7 shown in FIG. 4A is provided with a main body 71 made of a hard resin having insulating properties, for example, fastening bolts 72 inserted into through-holes which pass through the main body 71 in the vertical longitudinal direction, first engaging plates 73 installed at the top of the fastening bolts 72, and second engaging plates 74 (see FIG. 4B) installed on the bottom side.

Specifically the fastening means of the linking member 7 is provided with the first engaging plates 73 for engaging with a top-level joint 21d , the second engaging plates 74 for engaging with a bottom-level joint 21a , and the fastening bolts 72 for tightening the first engaging plates 73 and the second engaging plates 74. According to this configuration, since the four corners at the sides of the plurality of stacked secondary cells (single cells RB1, RB2, RB3, RB4) are attached and fixed in place in the vertical direction via the fastening bolts 72, expansion of the linked plurality of secondary cells is suppressed, and the secondary cells can each be securely fixed in place and prevented from becoming misaligned. In other words, the linking members 7 have a retention function of holding the plurality of stacked secondary cells therebetween.

In order to attach the fastening bolts 72 and tighten the first engaging plates 73 and the second engaging plates 74, a configuration may be adopted in which open holes through which a screw part of each of the fastening bolts 72 can pass are provided both to the first engaging plates 73 and to the second engaging plates 74, and the first engaging plates 73 and second engaging plates 74 are tightened with nut members attached to the fastening bolts 72. A configuration may also be adopted in which screw holes threaded with the screw parts of the fastening bolts 72 are provided to the second engaging plates 74 on the bottom side, and the second engaging plates 74 are moved and tightened by rotating the fastening bolts 72.

For example, the first engaging plates 73 used in the linking members 7 (7A) have open holes through which the screw parts of the fastening bolts 72 can pass, and the second engaging plates 74 have screw holes threaded with the screw parts of the fastening bolts 72. The first engaging plates 73 are mounted on the through-hole parts on top of the main body 71, the fastening bolts 72 are passed through the first engaging plates 73, and the second engaging plates 74 are screwed onto the bottoms of the screw parts and installed.

The first engaging plates 73 and second engaging plates 74 are preferably made of a mechanically strong sheet metal. When sheet metal is used, holes of a predetermined size can easily be formed, and screw holes can also be directly formed easily by burring or the like. Since the first engaging plates 73 and the second engaging plates 74 engage with the joint 21 between the exterior case and the cover member, the surfaces of the first engaging plates 73 and the second engaging plates 74, particularly the portions thereof that touch the exterior case or the cover member, are preferably subjected to an insulation treatment.

The main body 71 is shorter in length than the height of the plurality of stacked secondary cells, and has a first gap part 75 as an open notch communicated in the width direction, and a second gap part 76 as an open notch communicated in the longitudinal direction. The first gap part 75 is an open notch for preventing the plurality of stacked secondary cells (single cells) from interfering with the joint. The second gap part 76 is an open notch for preventing interference between the external terminals protruding from the sides of the secondary cells (single cells) and the terminal connecting member for connecting the external terminals to each other.

Since the main body 71 is shorter in length than the height of the plurality of stacked secondary cells, the height of the cell assembly M1 is about the same as the height of the plurality of stacked secondary cells, and the height of the cell assembly M1 can be kept to a minimum as a result. The main body 71 performs the function of covering and protecting the external terminals of the stacked secondary cells, the terminal connecting member, and other components. Specifically, the linking members 7 (7A) have a retention function of holding the plurality of stacked secondary cells therebetween, as well as a protective function of containing and protecting the external terminals, the terminal connecting member for connecting upper and lower external terminals to each other, and other components.

As described above, the linking member 7 (7A) is provided with the main body 71 shorter in length than the height of the plurality of stacked secondary cells, and the main body 71 has the first gap part 75 for preventing the plurality of stacked secondary cells from interfering with the joints, the second gap part 76 for preventing interference with the external terminals, and the through-holes formed in the length direction on either side of the external terminals. The fastening bolts 72, the first engaging plates 73 installed by the fastening bolts 72 to engage with the top-level joint 21d, and the second engaging plates 74 having screw holes for engaging with the bottom-level joint 21a and threading with the fastening bolts 72 are used as fastening means. The first engaging plates 73 are engaged with the top-level joint 21d, the second engaging plates 74 are engaged with the bottom-level joint 21a, and the fastening bolts 72 are rotated and attached to hold together into a single unit and fasten the plurality of stacked secondary cells.

Specifically, as shown in FIG. 4B, the first engaging plates 73 are mounted on the fastening bolts 72, the second engaging plates 74 are mounted on the fastening bolts 72, and the fastening bolts 72 are rotated, whereupon the second engaging plates 74 screwed onto the fastening bolts 72 move in the direction of the arrow D1 in the drawing. In other words, the first engaging plates 73 and the second engaging plates 74 can be tightened via the fastening bolts 72 so as to hold together into a single unit and fasten the plurality of stacked secondary cells therebetween.

According to the configuration described above, since the plurality of secondary cells is directly stacked, the stack can be made compact in the height direction. Since linking members 7 attached so as to prevent interference with connecting terminals or joints are used on the sides of the plurality of stacked secondary cells, the assembly can be made compact in the lateral direction as well. Since the four corners at the sides of the plurality of stacked secondary cells are attached and fixed in place in the vertical direction via the fastening bolts 72, expansion of the linked plurality of secondary cells is suppressed, and the secondary cells can each be securely fixed in place and prevented from becoming misaligned.

Specifically, the plurality of secondary cells (single cells RB1 through RB4) stacked vertically via the joints protruding on the sides of the cell canisters are linked using linking members having a main body length less than the height of the plurality of stacked secondary cells, and the cell assembly M1 of the present embodiment therefore has a linked configuration whereby the height thereof in the stacking direction can be minimized Since the external terminals of the single cells are provided on the sides of the cell canisters, electrical connections can also be made on the sides of the cell canisters, and the stack can be formed compactly in the height direction. A cell assembly can therefore be obtained in which wiring connection is facilitated and the plurality of secondary cells (single cells RB1 through RB4) can be compactly linked and securely fixed in place so that single cells do not become misaligned with each other.

The single cell used in the present embodiment is a stacked-type lithium secondary cell, for example. The lithium secondary cell is provided with a stacked-type electrode group 1 in which a plurality of positive electrode plates and negative electrode plates is stacked with separators therebetween. A secondary cell having relatively large capacity is obtained by increasing the surface area of the electrode plates and increasing the number of layers, and the large-capacity secondary cell can be applied as a storage cell for an electric automobile, a storage cell for power storage, or the like.

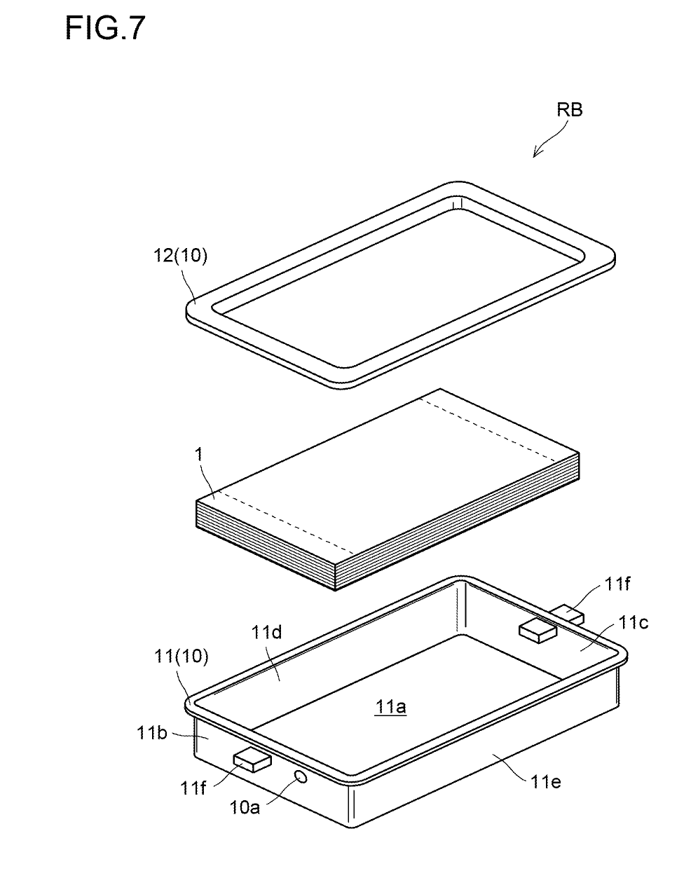

The specific configuration of a stacked-type lithium secondary cell RB and the electrode group 1 will next be described using FIGS. 7 through 10.

As shown in FIG. 7, the stacked-type lithium secondary cell RB is rectangular in plan view, and is provided with an electrode group 1 in which rectangular positive electrode plates, negative electrode plates, and separators are stacked. The electrode group 1 is housed in a cell canister 10 composed of a cover member 12 and an exterior case 11 formed as a core box provided with a bottom part 11a and side parts 11b through 11e, and charging and discharging are performed from external terminals 11f provided to side surfaces (e.g., the surfaces of the two opposing side parts 11b, 11c) of the exterior case 11.

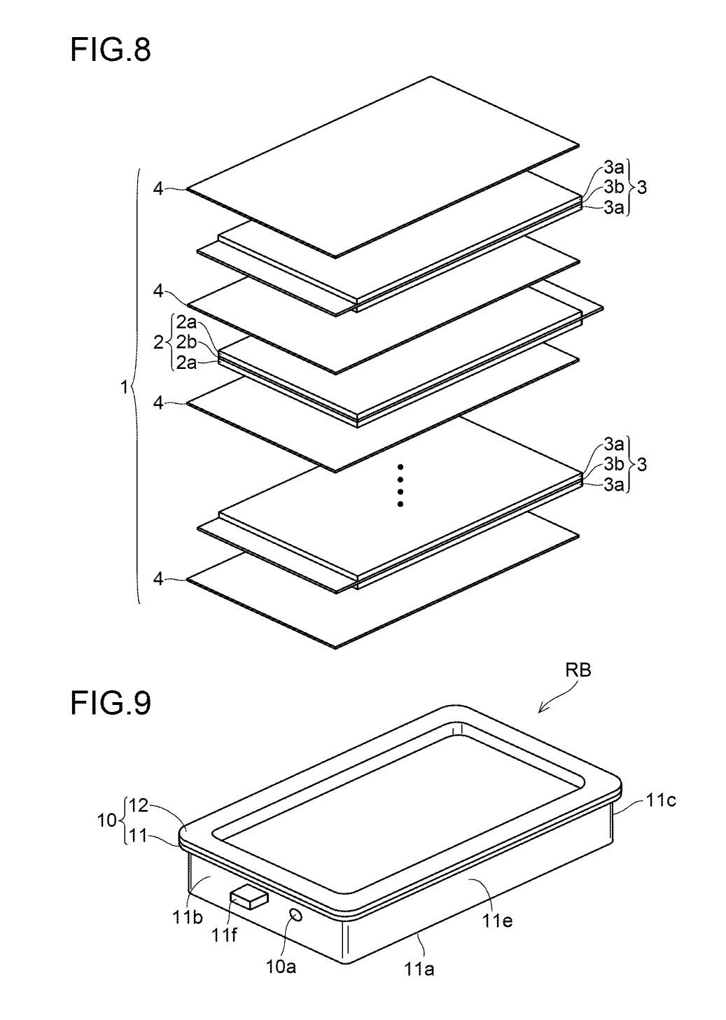

The electrode group 1 has a configuration in which a plurality of positive electrode plates and negative electrode plates is stacked with separators therebetween, and as shown in FIG. 8, positive electrode plates 2 in which positive electrode active material layers 2a composed of a positive electrode active material are formed on both sides of a positive electrode collector 2b (e.g., an aluminum foil), and negative electrode plates 3 in which negative electrode active material layers 3a composed of a negative electrode active material are formed on both sides of a negative electrode collector 3b (e.g., copper foil) are stacked with separators 4 therebetween.

The separators 4 provide insulation between the positive electrode plates 2 and the negative electrode plates 3, and lithium ions can move between the positive electrode plates 2 and the negative electrode plates 3 via an electrolyte solution filled into the exterior case 11.

The positive electrode active material of the positive electrode plates 2 may be an oxide containing lithium (LiCoO₂, LiNiO₂, LiFeO₂, LiMnO₂, LiMn₂O₄, or the like), a compound in which the transition metal in the above oxides is partially substituted with another metal element, or the like. Among these examples, a positive electrode active material is preferred that is capable of utilizing 80% or more of the lithium content of the positive electrode plates 2 for the battery reaction in normal use, in order to increase safety with respect to overcharge and other mishaps.

A material impregnated with lithium or a material that allows insertion/extraction of lithium is used as the negative electrode active material of the negative electrode plates 3. In particular, in order to obtain high energy density, a material is preferably used for which the lithium insertion/extraction potential is close to the deposition/solution potential of metallic lithium. Typical examples of the negative electrode active material include particulate (flake, lump, fibrous, whisker, spherical, granulated, and other forms of) natural graphite or artificial graphite.

Conductive materials, thickeners, binders, and the like may also be included in addition to the positive electrode active material of the positive electrode plates 2, and in addition to the negative electrode active material of the negative electrode plates 3. Any electron-conductive material that does not adversely affect the battery performance of the positive electrode plates 2 or the negative electrode plates 3 may be used as a conductive material, and examples thereof include carbon black, acetylene black, Ketjen Black, graphite (natural graphite, artificial graphite), carbon fibers, and other carbon materials or conductive metal oxides.

Examples of thickeners that can be used include polyethylene glycols, celluloses, polyacrylamides, poly N-vinylamides, poly N-vinylpyrrolidones, and the like. The binder serves to tether active material particles and conductive material particles, and examples of binders that can be used include polyvinylidene fluoride, polyvinyl pyridine, polytetrafluoroethylene, and other fluorine-based polymers; polyethylene, polypropylene, and other polyolefin-based polymers; styrene butadiene rubber, and the like.

A microporous polymer film is preferably used to form the separators 4. Specific examples of films that can be used include nylon, cellulose acetate, nitrocellulose, polysulfone, polyacrylonitrile, polyvinylidene fluoride, polypropylene, polyethylene, polybutene, and other polyolefin polymer films.

An organic electrolyte solution is preferably used as the electrolyte solution. Specific examples of organic solvents for the organic electrolyte solution include ethylene carbonate, propylene carbonate, butylene carbonate, diethyl carbonate, dimethyl carbonate, methyl ethyl carbonate, γ-butyrolactone, and other esters; tetrahydrofuran, 2-methyltetrahydrofuran, dioxane, dioxolane, diethyl ether, dimethoxyethane, diethoxyethane, methoxyethoxy ethane, and other ethers; dimethyl sulfoxide, sulfolane, methyl sulfolane, acetonitrile, methyl formate, methyl acetate, and the like. These solvents may be used singly or as mixtures of two or more types thereof

The organic solvent may include an electrolyte salt. Examples of electrolyte salts include lithium perchlorate (LiClO₄), lithium tetrafluoroborate, lithium hexafluorophosphate, lithium trifluoromethanesulfonate (LiCF₃SO₃), lithium fluoride, lithium chloride, lithium bromide, lithium iodide, lithium tetrachloroaluminate, and other lithium salts. These electrolyte salts may be used singly or as mixtures of two or more types thereof

The concentration of the electrolyte salt is not particularly limited, but is preferably about 0.5 mol/L to 2.5 mol/L, and more preferably about 1.0 mol/L to 2.2 mol/L. When the concentration of the electrolyte salt is less than about 0.5 mol/L, the carrier concentration in the non-aqueous electrolyte solution decreases, and there is a risk of increased resistance of the electrolyte solution. When the concentration of the electrolyte salt is higher than about 2.5 mol/L, the degree of dissociation of the salt as such is reduced, and the carrier concentration in the electrolyte solution may not increase.

The cell canister 10 is provided with the exterior case 11 and the cover member 12, and is composed of iron, nickel-plated iron, stainless steel, aluminum, or the like. In the present embodiment, the cell canister 10 is formed so that the external shape thereof is essentially flat rectangular shape when the exterior case 11 and the cover member 12 are assembled, as shown in FIG. 9.

The exterior case 11 is a box shape having the bottom part 11a with a substantially rectangular bottom surface, and four side parts 11b through 11e provided upright from the bottom part 11a, and the electrode group 1 is housed inside the box shape. The electrode group 1 is provided with a positive electrode collector terminal linked to collector tabs of the positive electrode plates, and a negative electrode collector terminal linked to collector tabs of the negative electrode plates, and an external terminal 11f electrically connected to the collector tabs is provided to each side part of the exterior case 11. The external terminals 11f are provided in two locations, e.g., in the opposing side parts 11b, 11c. The reference symbol 10a refers to a fill opening through which the electrolyte solution is injected.

After the electrode group 1 is housed in the exterior case 11 and the collector terminals are connected to the respective external terminals, or the respective external terminals are connected to the collector terminals of the electrode group 1, the electrode group 1 is housed in the exterior case 11, and the external terminals are attached in predetermined locations of the exterior case, the cover member 12 is fixed to an opening edge of the exterior case 11. The electrode group 1 is then sandwiched between the cover member 12 and the bottom part 11a of the exterior case 11, and the electrode group 1 is retained inside the cell canister 10. The cover member 12 is fixed to the exterior case 11 by laser welding or the like, for example. The collector terminals and the external terminals may also be connected by ultrasonic welding, laser welding, resistance welding, or other welding, or through use of an electrically conductive adhesive or the like.

As described above, the stacked-type secondary cell according to the present embodiment has a configuration provided with the electrode group 1 in which a plurality of positive electrode plates 2 and negative electrode plates 3 is stacked with separators 4 therebetween; the exterior case 11 for housing the electrode group 1, the exterior case 11 being filled with an electrolyte solution; the external terminals 11f provided to the exterior case 11; the positive and negative collector terminals for electrically connecting the positive and negative electrode plates and the external terminals 11f; and the cover member 12 installed on the exterior case 11.

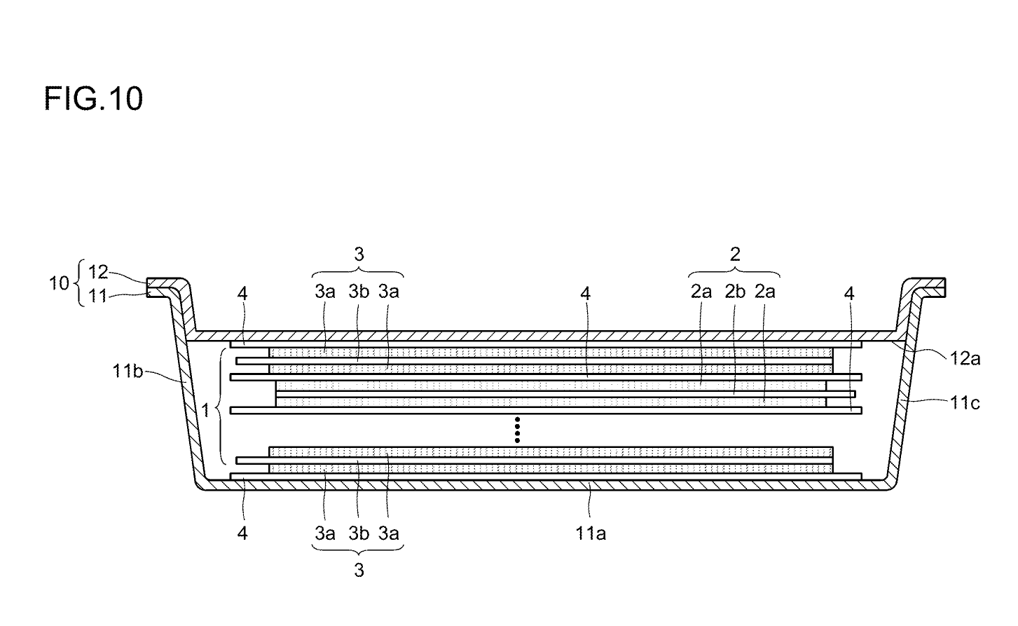

In the electrode group 1 housed in the exterior case 11, the positive electrode plates 2 in which positive electrode active material layers 2a are formed on both sides of a positive electrode collector 2b, and the negative electrode plates 3 in which negative electrode active material layers 3a are formed on both sides of a negative electrode collector 3b are stacked with separators 4 therebetween, and separators 4 are further provided on both end sides of the electrode group 1, as shown in FIG. 10, for example. A configuration may also be adopted in which, instead of providing separators 4 on both end surfaces, the electrode group 1 is covered by a resin film capable of insulating the electrode group 1, the resin film being wrapped around the electrode group 1 and having the same properties as the separators 4. In either configuration, a material permeable to the electrolyte solution and having insulating properties is layered on the top surface of the stacked electrode group 1. The cover member 12 can therefore come in direct contact with the top surface, and a predetermined pressure can be applied via the cover member 12.

In order to directly stack the secondary cells, the cell canisters 10 thereof are preferably insulated from each other by, for example, applying an insulating coating to the surfaces of the cell canisters 10. The reason for this is that because the cell canister surfaces have an intermediate potential between that of the negative electrodes and the positive electrodes, short-circuiting occurs between the cell canister surfaces particularly when contact occurs between the surfaces of cell canisters in which large-capacity (e.g., 50 Ah or greater) single cells are connected in series.

In the stacking of cell canisters 10, when the cell canisters are stacked in order with insulating sheets therebetween, for example, upper and lower cell canisters are reliably insulated from each other, short-circuiting of stacked cell canisters with each other is reliably prevented, and a predetermined cell capability is normally demonstrated. In a configuration in which cell canisters are insulated from each other, short-circuiting between stacked cell canisters 10 can be reliably prevented even in a case in which there is inadequate insulation of the surface of either the exterior case 11 or the cover member 12 of a cell canister 10. Also when insulating sheets are interposed between the cell canisters, the sheets serve as cushioning, and the secondary cells can be securely fixed in place so as not to become misaligned with each other.

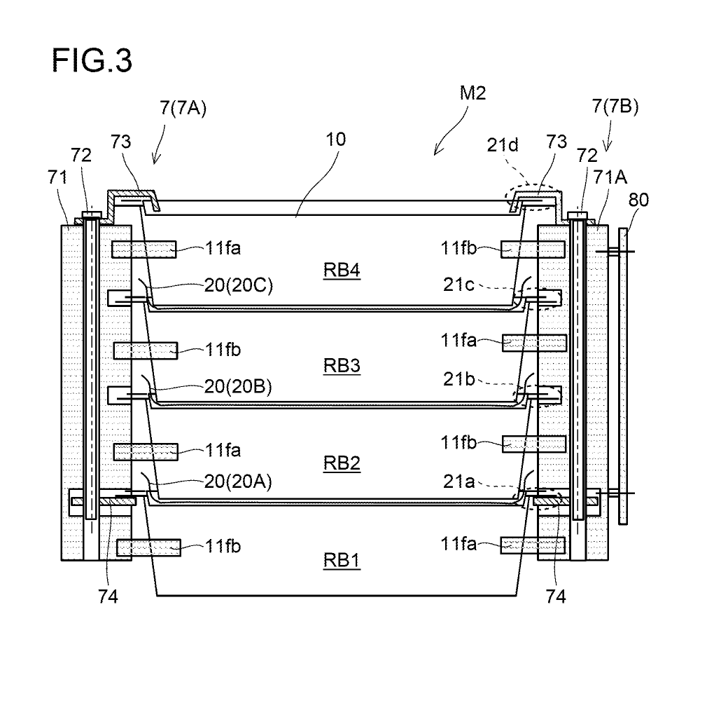

For example, an insulating sheet 20A is interposed between the single cells RB1, RB2, an insulating sheet 20B is interposed between the single cells RB2, RB3, and an insulating sheet 20C is interposed between the single cells RB3, RB4, as in the cell assembly M2 according to a second embodiment shown in FIG. 3. In the cell assembly M2 shown in FIG. 3, single cells RB1, RB2, RB3, RB4 are stacked in this order and combined into a single unit using linking members 7 (7B) via joints 21 (21a through 21d) of exterior cases and cover members, the same as in the cell assembly M1 described previously.

The insulating sheets 20 (20A, 20B, 20C) may be thin film sheets of polycarbonate resin or the like having a thickness of about 0.1 mm, for example, and do not affect the ability to stack a plurality of single cells compactly in the height direction.

FIG. 3 shows an example in which a circuit unit 80 is provided to the main body 71A of one of the linking members 7 (7B). The circuit unit 80 includes a protective circuit or a wiring part for connecting a power supply line, signal line, or the like. The protective circuit has the function of controlling charging/discharging and other operations of the electrode group 1, or the function of preventing an overcurrent from flowing to an IC element or other control element. In a configuration in which a circuit unit 80 for controlling and protecting the stacked and linked secondary cells is provided to a linking member 7 (7B), an electrical component is provided to the sides of the cell canisters 10, and wiring connection is made where the electrical component is provided.

Specifically, the linking member 7 (7B) has the electrical function of placing the circuit unit 80 in a position away from the cell canisters. Wiring connection of the cell assembly or electrical connection between the stacked and linked secondary cells can be performed at the side of the cell canisters 10, and even when a unit chassis (chassis for housing a plurality of cell assemblies as a single unit) having a restricted height is used, wiring connection of the circuit unit 80 can easily be performed from one side.

Since the circuit unit 80 is disposed on a side part separated from the cell canisters 10, a configuration is obtained in which the circuit unit 80 can be provided in a position separated from the electrode group, which is a heat source, and the effects of heat on the circuit unit 80 can be suppressed. Since the circuit unit 80 is also disposed at an open part on one side, heat does not accumulate, and cooling by air can easily occur.

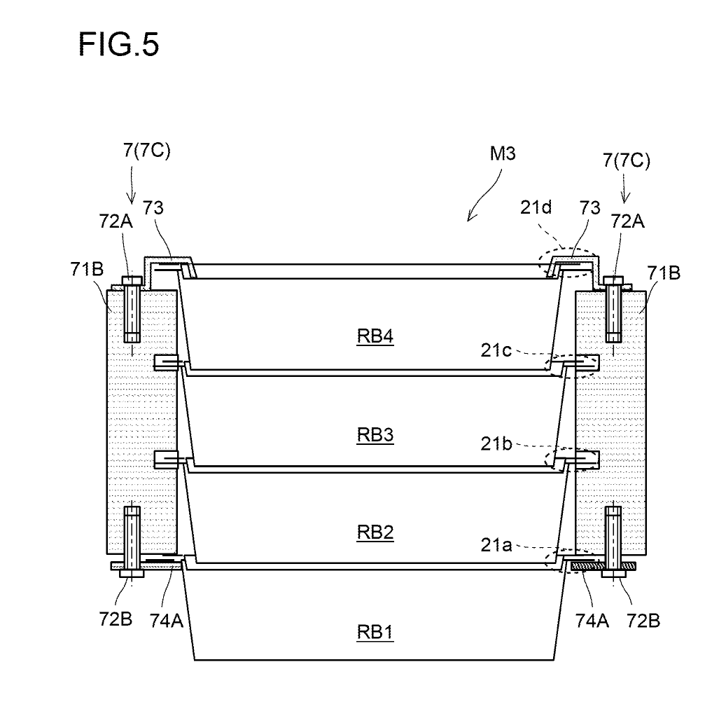

The fastening means provided to the linking members 7 (7A, 7B) is not limited to long fastening bolts 72 inserted into through-holes provided vertically in the main body 71 described above, and short fastening bolts provided at the top and bottom may also be used. Such a configuration is described using FIG. 5.

In the cell assembly M3 of the third embodiment shown in FIG. 5, single cells RB1, RB2, RB3, RB4 are stacked in this order and combined into a single unit using linking members 7 (7B) via joints 21 (21a through 21d) of exterior cases and cover members, the same as in the cell assembly M1 described previously. The cell assembly M3 differs from the cell assembly M1 in that fastening bolts 72A are used to secure the first engaging plates 73 installed on the top-level joint 21d, and fastening bolts 72B are used to secure second engaging plates 74A installed on the bottom-level joint 21a.

In this configuration, the second engaging plates 74A have open holes through which the screw parts of the fastening bolts 72B can pass, and a main body 71B is provided with screw holes for screwing in the fastening bolts 72A, 72B. When the upper and lower fastening bolts 72A, 72B are screwed in, it is apparent that the total length of the main body 71B is fixed by the first engaging plates 73 and the second engaging plates 74A in a manner in which the plurality of stacked secondary cells can be held together as a single unit therebetween.

In the same manner in both the configuration provided with fastening bolts 72 inserted into through-holes and the configuration provided with fastening bolts 72A, 72B screwed into screw holes, bolt installation holes for installing fastening bolts are provided on both the left and right sides of the second gap parts 76 of the linking members 7, the fastening bolts are installed in the bolt installation holes on the left and right sides, the first engaging plates 73 are installed on the fastening bolts and engaged with the top-level joint, the second engaging plates 74A are installed on the fastening bolts and engaged with the bottom-level joint, the fastening bolts are rotated and attached, and the plurality of stacked secondary cells is held together as a single unit and fastened.

In the configuration of the cell canisters 10, the joints at which the exterior cases 11 and the cover members 12 are joined may be formed by wrapping the rims thereof around each other and sealing the rims together, instead of by the joints 21 (21a through 21d) described above, at which the flat plate-shaped rims are placed on top of each other and laser-welded together.

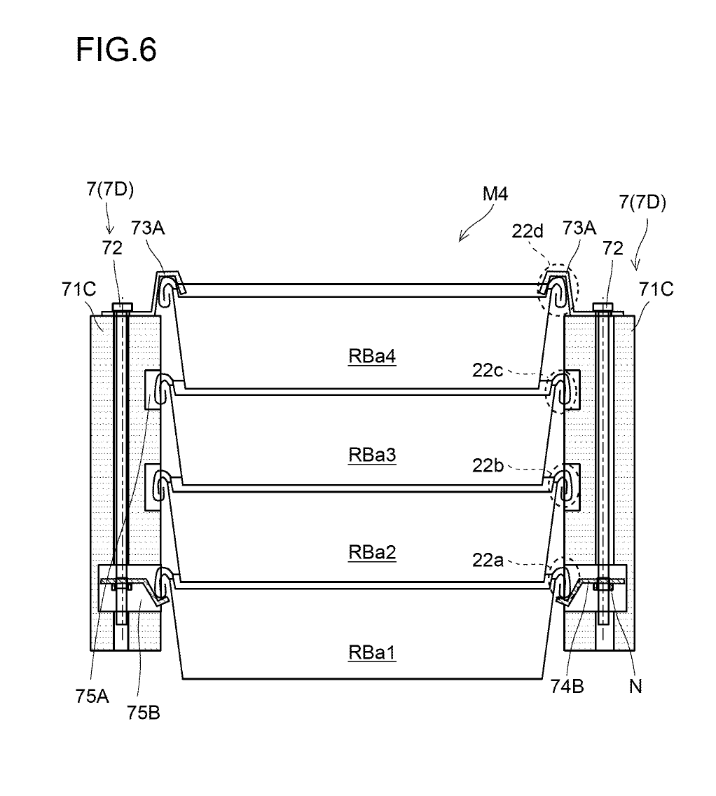

A configuration in which a linking member is installed via a joint 22 formed by wrapping rims around each other and sealing the rims together will be described using FIG. 6.

In the cell assembly M4 according to a fourth embodiment shown in FIG. 6, single cells RBa1, RBa2, RBa3, RBa4 having joints 22 (22a through 22d) formed by wrapping rims around each other and sealing the rims together are stacked in order, and the single cells are combined into a single unit using linking members 7 (7D) via the joints 22.

First engaging plates 73A shaped so as to be adapted to the wraparound portion are used as the engaging plates installed at the top-level joint 22d, and second engaging plates 74B shaped so as to be adapted to the wraparound portion are used as the engaging plates installed at the bottom-level joint 22a.

Open notch parts provided to each main body 71C include a first gap part 75A communicated in the width direction for preventing collisions with the joints, and a second gap part 76 (see FIG. 4A) communicated in the longitudinal direction to prevent interference between the external terminals and a terminal connecting member for connecting the external terminals to each other.

A first gap part 75B slightly larger than the first gap part 75A is provided as an open notch part in the location at which the second engaging plates 74B installed on the bottom-level joint 22a are provided.

FIG. 6 shows an example in which nut members N are used at the bottom of the second engaging plates 74B and the fastening bolts 72 inserted through the through-holes passing vertically through the main body 71C, but this configuration is not limiting, and screw holes may also be formed in the second engaging plates 74B, or open holes through which a screw part can pass may be provided in the same manner as in the first engaging plates 73A, and the upper and lower fastening bolts 72A, 72B may be directly screwed into the main body.

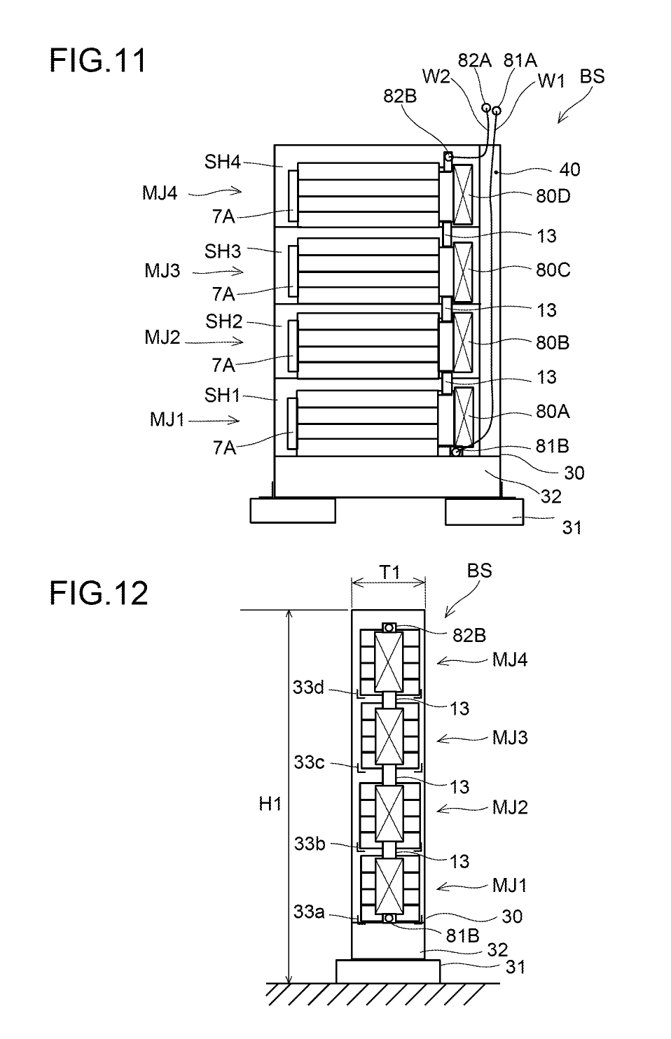

A cell assembly in which a plurality of single cells is stacked has been described above, but it is also possible to construct a large-capacity battery system by connecting a plurality of modularized cell assembly modules in which a circuit unit including a protective circuit and a wiring part is combined into a single unit on one side of a cell assembly. This battery system will be described using FIGS. 11 and 12.

FIG. 11 is a rough front view showing the overall configuration of the battery system BS according to the present embodiment, and FIG. 12 is a rough side view of the same.

As shown in FIG. 11, the battery system BS has a configuration in which cell assembly modules MJ in which the cell assemblies M1, M2, M3, M4 are modularized are housed as a single unit in a unit chassis 30. The unit chassis 30 is provided with a pedestal 31, a plurality of shelves SH (SH1 through SH4) is provided inside the chassis, and the cell assembly modules MJ (MJ1 through MJ4) are installed on the shelves SH. A power distribution part 40 is provided on one side inside the chassis, e.g., on the same side that the circuit units of the cell assembly modules MJ are provided.

Specifically, the battery system BS is provided with a plurality of levels of shelves SH (SH1 through SH4) in which a plurality of cell assembly modules MJ each provided with a predetermined number of secondary cells is housed on separate levels, and the battery system BS is provided with the unit chassis 30 in which the power distribution part 40 is provided on the side on which the circuit units of the cell assembly modules MJ (MJ1 through MJ4) are provided.

Through this configuration, since each of the cell assembly modules MJ (MJ1 through MJ4) is configured so that the height thereof is minimized, a unit chassis 30 having a low height can be used even in a configuration in which a plurality of cell assembly modules MJ (MJ1 through MJ4) is installed. In particular, since the cell assemblies are built using linking members whose main body length is less than the height of the plurality of stacked secondary cells, the height of each shelf SH can be kept to a minimum. Since cell assembly modules MJ (MJ1 through MJ4) thus configured are stacked in the height direction to construct the battery system BS, it is possible to obtain a battery system BS having small depth and height.

When the cell assembly modules MJ (MJ1 through MJ4) are connected to each other, the external terminals protruding on the side on which the circuit units 80 (80A through 80D) are provided are connected to each other via connecting terminals 13, and connected bottom-side external terminals and top-side external terminals have mutually different polarities. The connecting terminals 13 are the same as the terminal connecting member for connecting the external terminals of the secondary cells to each other when a cell assembly is created. Specifically, the connecting terminals 13 are connecting members for electrically connecting the cell assembly modules MJ to each other.

In a configuration in which the external terminals of upper and lower stacked cell assembly modules MJ have different polarities, when a plurality of cell assembly modules MJ (MJ1 through MJ4) is installed, external terminals on the same side of upper and lower cell assembly modules MJ can be connected to each other in series, and wiring connection is therefore facilitated. Since upper and lower cell assembly modules MJ are directly connected to each other using the connecting terminals 13, there is no need to devise extra wiring routes, and the gaps between upper and lower cell assembly modules can be minimized.

The shelves SH are preferably provided with an open space for allowing the connecting terminals 13 to be installed in a substantially straight line. Through this configuration, the external terminals on the same side of upper and lower cell assembly modules can be directly linked to each other using a connecting terminal 13 of small length. Connection is therefore facilitated, and the gaps between upper and lower cell assembly modules can be minimized

The power distribution part 40 is a passage for various wires, and a DC power supply, a monitoring circuit, a protective circuit, or various sensors and other electrical components for controlling a secondary cell are provided in the power distribution part 40. Power supply wiring W1 for connecting an input-side power supply terminal 81A and a unit input-side terminal 81B is provided for this purpose. The upper and lower cell assembly modules MJ are connected via the connecting terminals 13, a unit output-side terminal 82B is provided to the connecting terminal connected to an external terminal of the top-level cell assembly module MJ4, and the unit output-side terminal 82B is connected to an output-side power supply terminal 82A by power supply wiring W2.

Since the circuit units 80 (80A through 80D) of the cell assembly modules MJ and the power distribution part 40 for controlling the battery system as a whole are disposed on one side of the unit chassis 30, the wiring connection and other operations for constructing the battery system can be performed from one side thereof. The height dimension can also be kept to the minimum length that allows installation of the cell assembly modules MJ (MJ1 through MJ4). A battery system can therefore be obtained in which the cell assembly modules can be compactly combined, and in which wiring connection and other operations can easily be performed.

As shown in FIG. 12, the cell assembly modules MJ (MJ1 through MJ4) are supported using shelf plates 33 (33a through 33d) configured so as to support both side portions on either side of the open space. Through such a configuration, since the cell assembly modules MJ composed of a plurality of stacked secondary cells are stacked only vertically, the width T1 (depth when viewed from the front) thereof can be reduced to slightly larger than the width of the secondary cells. Since the gaps between upper and lower cell assembly modules can also be reduced, the installation height H1 can be kept small.

The unit chassis 30 also has a raised floor part 32 of a predetermined height between the pedestal 31 and a shelf SH (SH1), the raised floor part 32 being disposed on the pedestal 31, and the shelf SH1 and the power distribution part 40 are provided on top of the raised floor part 32. Through this configuration, since the raised floor part 32 of a predetermined height is present on the pedestal 31, water does not penetrate into a cell assembly module MJ (MJ1) or the power distribution part 40 and cause short-circuiting or other malfunctions even when rain or other precipitation falls and water accumulates on the periphery thereof The raised floor part 32 is also preferred because it acts as an air passage for allowing the flow of cool air, and enables an efficiently operable battery system BS to be obtained.

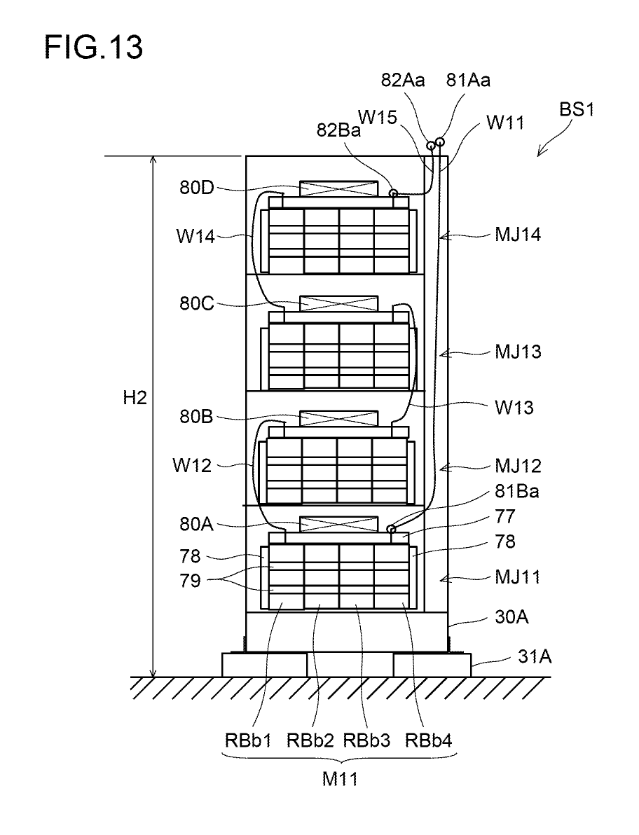

In the conventional battery system BS1 shown in FIG. 13, for example, a unit chassis 30A is provided on a pedestal 31A, a plurality of cell assembly modules MJ11 through MJ14 is housed therein, and a power distribution part 40 is provided on one side thereof, the same as in the present embodiment. However, each cell assembly M11 is configured such that stacked-type secondary cells RBb1, RBb2, RBb3, RBb4 are combined via an integrating plate 78 and an integrating band 79, a terminal cover 77 is provided, and a circuit unit 80 (80A through 80D) is provided on the terminal cover 77. The external terminals on top of each cell assembly module are connected to the cell assembly module above and below, respectively, to link the cell assembly modules. A space is therefore needed between the stacked cell assembly modules in the battery system BS1 thus configured, which increases the installation height H2 of the apparatus as a whole.

The wiring in this case is the same as in the abovementioned embodiment, in that power supply wiring W11 for connecting an input-side power supply terminal 81Aa and a unit input-side terminal 81Ba is routed via the power distribution part 40, and a unit output-side terminal 82Ba and an output-side power supply terminal 82Aa are connected by power supply wiring W15. The present configuration differs from the embodiment in that connection wiring W12, W13, W14 is provided for connecting upper and lower cell assembly modules to each other.

Since the connection wiring W12 and W14 is on the opposite side from where the power distribution part 40 is provided, not all of the wiring connection can be performed from one side in this configuration.

The battery system BS of the present embodiment constructed by creating battery assemblies in which a plurality of stacked-type secondary cells is stacked in the stacking direction thereof, modularizing the battery assemblies, and vertically assembling the modules is therefore preferred from the viewpoint of constructing a compact battery system that is configured having a small depth and height, and in which connection, wiring, and other electrical work can be easily performed.

In the cell assembly of the present invention as described above, since a plurality of secondary cells stacked vertically is linked together via linking members for holding together the joints which protrude on the sides of the cell canisters, a linked configuration is obtained in which the height in the stacking direction can be minimized. The plurality of secondary cells (single cells) can therefore be stacked and assembled with a compact height, and a cell assembly can be obtained in which the single cells can be securely fixed in place without becoming misaligned with each other.

In a configuration in which the linking members are provided with gap parts (open notches) for containing the external terminals and the terminal connecting member, and circuit units are provided, the linking members have a retention function of holding the plurality of stacked secondary cells therebetween, an electrical function of placing the circuit unit in a position away from the cell canisters, and a protective function of containing and protecting the external terminals, the terminal connecting member for connecting upper and lower external terminals to each other, and other components. The use of these linking members therefore enables compact assembly in the transverse direction as well, provides electrical safety, and facilitates wiring connection in the cell assembly.

In the battery system of the present invention in which cell assembly modules comprising modularized cell assemblies are vertically combined, each cell assembly module is configured so that the height thereof is minimized The height of a structure in which a plurality of cell assembly modules is installed can therefore be reduced. Since the battery system is constructed by stacking a plurality of cell assembly modules in the height direction, a compact battery system can be obtained having a small depth and height.

Specifically, through the present invention, since a plurality of secondary cells stacked vertically is linked via linking members for holding together the joints which protrude on the sides of the cell canisters, a cell assembly having a linked configuration is obtained in which the height in the stacking direction can be minimized Since the external terminals are provided on the sides of the cell canisters, the electrical connections thereof can be made on the sides of the cell canisters, and the stack can be made compact in the height direction. It is therefore possible to obtain a cell assembly in which the plurality of secondary cells (single cells) can be compactly linked, the single cells can be securely fixed in place so as not to become misaligned with each other, and wiring connection is facilitated. Since the battery system is configured such that a power distribution part is provided on a side of a unit chassis in which a plurality of modularized cell assemblies is stacked and housed, a battery system can be obtained in which cell assembly modules can be compactly assembled, and wiring connection and other operations can be facilitated.

### INDUSTRIAL APPLICABILITY

Therefore, the cell assembly and battery system of the present invention can be suitably used in large-capacity power storage cells in which there is a need for compactness and ease of wiring connection.

1. A cell assembly comprising:
a stacked-type secondary cell provided with an electrode group in which a plurality of positive electrode plates and negative electrode plates is stacked, interposed by a separator; and
a linking member for linking together into a single unit a plurality of said secondary cells; wherein
said secondary cell is provided with an exterior case for housing said electrode group, external terminals provided to opposing surfaces on both sides of the exterior case, and a cover member for sealing an open part of said exterior case, an electrolyte solution is injected into a cell canister formed by the exterior case and the cover member, and a joint between said exterior case and said cover member is provided so as to protrude outward from an external peripheral edge of said exterior case; and
said linking member is interposed so as to hold said joint on a top level and said joint on a bottom level therebetween, the joints being stacked vertically in the stacking direction of said plurality of secondary cells.

2. The cell assembly according to claim 1, wherein
said linking member comprises fastening means for holding the bottom-level joint and top-level joint of said plurality of stacked secondary cells therebetween and fixing together into a single unit the plurality of secondary cells, and said linking member links together into a single unit said plurality of secondary cells via said joints on the sides on which said external terminals are provided, while staying clear of said external terminals and of a terminal connecting member for connecting upper and lower external terminals to each other.

3. The cell assembly according to claim 1, wherein
said linking member is provided with a circuit unit for protecting said plurality of secondary cells.

4. The cell assembly according to claim 3, wherein
said linking member has a retention function of holding said plurality of stacked secondary cells therebetween, an electrical function of placing said circuit unit in a position away from said cell canisters, and a protective function of containing and protecting said external terminals, the terminal connecting member for connecting upper and lower external terminals to each other, and other components.

5. The cell assembly according to claim 2, wherein
said fastening means comprises first engaging plates for engaging with said top-level joint, second engaging plates for engaging with said bottom-level joint, and fastening bolts for tightening the first engaging plates and the second engaging plates.

6. The cell assembly according to claim 5, wherein
said linking member is provided with a main body shorter in length than the height of the plurality of stacked secondary cells, and the main body is provided with a first gap part for preventing interference with the joints of said plurality of stacked secondary cells, a second gap part for preventing interference with said external terminals and said terminal connecting member, and bolt installation holes for installing said fastening bolts on both left and right sides of said second gap part;
said fastening bolts are installed in said bolt installation holes on the left and right sides, said first engaging plates are installed on said fastening bolts and engaged with said top-level joint, said second engaging plates are installed on said fastening bolts and engaged with said bottom-level joint, said fastening bolts are rotated and attached, and the plurality of stacked secondary cells is held together as a single unit and fastened.

7. The cell assembly according to claim 1, wherein
said linking member is formed of a resin having insulating properties.

8. The cell assembly according to claim 1, wherein
said vertically stacked cell canisters are insulated from each other.

9. The cell assembly according to claim 1, wherein
external terminals protruding on the sides of said plurality of stacked secondary cells have alternatingly opposite polarities, and upper and lower external terminals are sequentially connected in series.

10. A battery system comprising:
a cell assembly module in which a circuit unit including a protective circuit and a wiring part is combined into a single unit and modularized with one side part of the cell assembly according to claim 1; and
a unit chassis for housing a plurality of said cell assembly modules as a single unit; wherein
said unit chassis is provided with a plurality of levels of shelves in which a plurality of said cell assembly module is individually housed, and a power distribution part is provided on a side of the unit chassis on which said circuit unit is provided.

11. The battery system according to claim 10, wherein
when said cell assembly modules are connected to each other, the external terminals protruding on the side on which said circuit unit is provided are connected to each other via connecting terminals, and connected bottom-side external terminals and top-side external terminals have mutually different polarities.

12. The battery system according to claim 11, wherein
said shelves are provided with an open space for allowing said connecting terminals to be installed in a substantially straight line.

13. The battery system according to claim 10, wherein
said unit chassis has a raised floor part of a predetermined height disposed on a pedestal, the raised floor part being disposed between said pedestal and said shelves, and said shelves and said power distribution part are provided on top of the raised floor part.
